(19) United States
(12) Patent Application Publication
(10) Pub. No.: US 2026/0106168 A1
(43) Pub. Date: Apr. 16, 2026

(54) CURRENT COLLECTOR AND BATTERY

(71) Applicant: TOYOTA JIDOSHA KABUSHIKI KAISHA, Toyota-shi (JP)

(72) Inventors: Masayoshi HAGA, Nagoya-shi (JP); Tetsuya MIMURA, Chiryu-shi (JP); Atsushi SUGIHARA, Toyota-shi (JP); Satoshi MORIYAMA, Nagoya-shi (JP); Masaki FURUKAWA, Toyota-shi (JP); Keita YAMASHITA, Nagoya-shi (JP); Ryuto SAKAMOTO, Okazaki-shi (JP); Hideyuki NAGAI, Nagoya-shi (JP)

(73) Assignee: TOYOTA JIDOSHA KABUSHIKI KAISHA, Toyota-shi (JP)

(21) Appl. No.: 19/314,132

(22) Filed: Aug. 29, 2025

(30) Foreign Application Priority Data
Oct. 16, 2024 (JP) 2024-180950

(51) Int. Cl. H01M 4/66; H01M 10/0587

(52) U.S. Cl. CPC H01M 4/667; H01M 4/668; H01M 10/0587

(57) ABSTRACT

A current collector includes an insulative support layer, a conductive support layer, a first conductive layer, and a tab part. The insulative support layer is made of a resin composition having electrical insulation properties. The conductive support layer lies adjacent to the insulative support layer. The first conductive layer is laminated on both of the insulative support layer and the conductive support layer. The tab part lies next to the conductive support layer through the first conductive layer and is joined to the first conductive layer by ultrasonic joining.

### CROSS-REFERENCE TO RELATED APPLICATION

This application claims priority to Japanese Patent Application No. 2024-180950 filed on Oct. 16, 2024. The disclosure of the above-identified application, including the specification, drawings, and claims, is incorporated by reference herein in its entirety.

### BACKGROUND

### 1. Technical Field

The present disclosure relates to a current collector and a battery.

### 2. Description of Related Art

Japanese Unexamined Patent Application Publication (Translation of PCT Application) No. 2024-510696 (JP 2024-510696 A) discloses a polar plate. The polar plate includes a current collector and an electrical connection member. The electrical connection member is electrically connected to the current collector. The electrical connection member and the current collector are connected to each other by welding at an edge of the current collector. The welded connection region is called a junction welded region. The current collector includes a support layer and a conductive layer. The conductive layer is installed on one surface of the support layer. For the support layer, an organic polymeric material or a polymeric composite material is used.

### SUMMARY

When the conductive layer and the electrical connection member (tab part) are welded to each other, the support layer having insulation properties may melt and part of the support layer may become mixed into the welded connection region. In this case, electrical resistance in the welded connection region becomes high. Consequently, when a current flows between the conductive layer and the electrical connection member, the welded connection region generates heat. Moreover, in the above case, joint strength between the conductive layer and the electrical connection member decreases in the welded connection region.

The present disclosure has been made in view of these problems, and an object thereof is to provide a current collector and a battery including this current collector in which heat generation in a joint portion between a conductive layer and a tab part is reduced and the joint strength of the joint portion is improved.

A current collector according to one aspect of the present disclosure includes an insulative support layer, a conductive support layer, a first conductive layer, and a tab part. The insulative support layer is made of a resin composition having electrical insulation properties. The conductive support layer lies adjacent to the insulative support layer. The first conductive layer is laminated on both of the insulative support layer and the conductive support layer. The tab part lies next to the conductive support layer through the first conductive layer and is joined to the first conductive layer by ultrasonic joining.

A battery according to one aspect of the present disclosure includes an electrode body and an external terminal. The electrode body includes a first electrode, a second electrode, and a separator. The first electrode includes a current collector and a one-side active material layer. The current collector includes an insulative support layer, a conductive support layer, a first conductive layer, and a tab part. The insulative support layer is made of a resin composition having electrical insulation properties. The conductive support layer lies adjacent to the insulative support layer. The first conductive layer is laminated on both of the insulative support layer and the conductive support layer. The tab part lies next to the conductive support layer through the first conductive layer and is joined to the first conductive layer by ultrasonic joining. The one-side active material layer is laminated on the first conductive layer. The separator is laminated on the one-side active material layer. The second electrode is laminated on the one-side active material layer through the separator. The external terminal is electrically connected to the tab part.

According to the present disclosure, heat generation in the joint portion between the conductive layer and the tab part is reduced and the joint strength of the joint portion can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view showing a battery according to one embodiment;

FIG. 2 is a sectional view of an electrode body of FIG. 1 as seen in the arrow direction of line II-II;

FIG. 3 is a sectional view of the electrode body of FIG. 1 as seen in the arrow direction of line III-III;

FIG. 4 is a schematic sectional view of part of the electrode body of FIG. 1 as seen in the arrow direction of line IV-IV;

FIG. 5 is a developed view of a first electrode; and

FIG. 6 is a partial sectional view showing a close-up of region VI of the first electrode in FIG. 3.

### DETAILED DESCRIPTION OF EMBODIMENTS

A current collector and a battery according to one embodiment of the present disclosure will be described with reference to the drawings. In the drawings to be referred to below, the same or equivalent members are denoted by the same reference numerals.

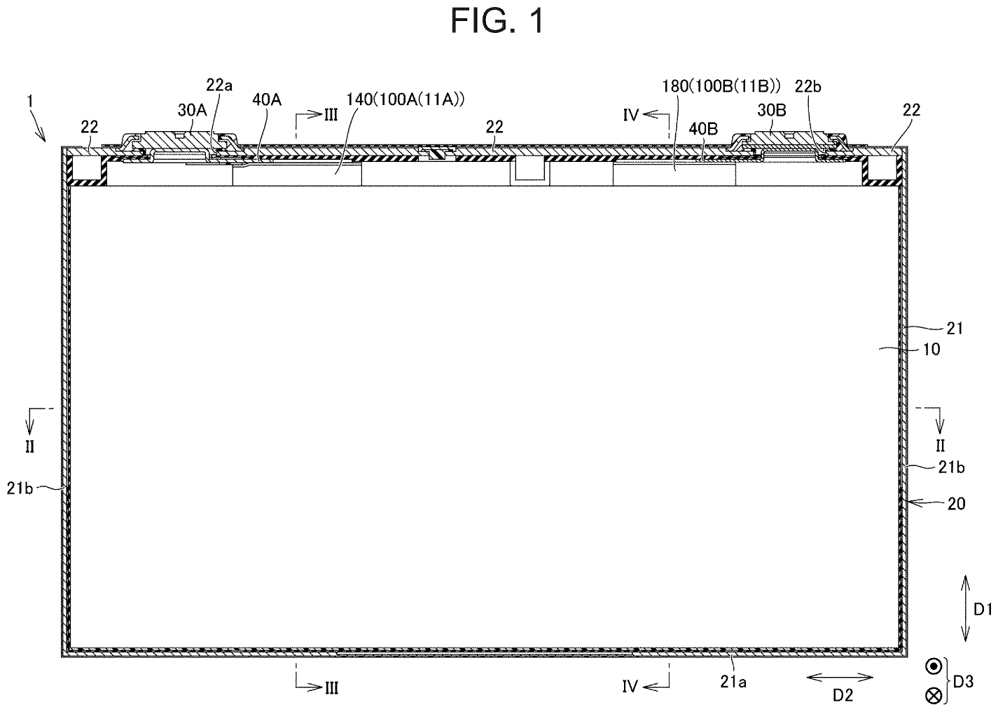

FIG. 1 is a sectional view showing the battery according to one embodiment. A battery 1 shown in FIG. 1 is a so-called rectangular battery. The battery 1 may be a secondary battery configured to be chargeable and dischargeable, such as a lithium-ion battery or a nickel-metal hydride battery. The battery 1 can be used as, for example, a cell included in an electricity storage module installed in an electrified vehicle.

As shown in FIG. 1, the battery 1 according to one embodiment of the present disclosure includes an electrode body 10, a case 20, a first external terminal 30A, a second external terminal 30B, a first coupling member 40A, and a second coupling member 40B. First, components of the battery 1 other than the electrode body 10 will be described.

The case 20 has electrical conductivity. A part of the case 20 that has electrical conductivity is made of metal, for example, aluminum. The case 20 houses the electrode body 10. The case 20 also houses an electrolytic solution (not shown).

The case 20 includes a case main body 21 and a lid 22. The case main body 21 includes a bottom wall 21a and a peripheral wall 21b rising from the bottom wall 21a.

The lid 22 is joined to the peripheral wall 21b by welding or the like so as to close an opening of the peripheral wall 21b. In the lid 22, a first coupling hole 22a and a second coupling hole 22b are formed.

The first external terminal 30A and the second external terminal 30B are provided in the battery 1 so as to be exposed to an outside. The first coupling member 40A and the second coupling member 40B have electrical conductivity. At least part of each of the first coupling member 40A and the second coupling member 40B is disposed inside the case 20.

The first external terminal 30A or the first coupling member 40A is inserted through the first coupling hole 22a. The first external terminal 30A is electrically connected to the first coupling member 40A. Specifically, the first external terminal 30A and the first coupling member 40A are joined to each other. The first coupling member 40A is joined to the electrode body 10. Thus, the first external terminal 30A is electrically connected to the electrode body 10.

The second external terminal 30B or the second coupling member 40B is inserted through the second coupling hole 22b. The second external terminal 30B is electrically connected to the second coupling member 40B. Specifically, the second external terminal 30B and the second coupling member 40B are joined to each other. The second coupling member 40B is joined to the electrode body 10. Thus, the second external terminal 30B is electrically connected to the electrode body 10.

In this embodiment, the first external terminal 30A is a positive electrode terminal and the second external terminal 30B is a negative electrode terminal. The first external terminal 30A and the second external terminal 30B lie next to each other in a second direction D2. The second direction D2 is a direction orthogonal to a first direction D1.

Next, the electrode body 10 will be described. The battery 1 according to this embodiment includes a plurality of electrode bodies 10. The battery 1 typically includes two electrode bodies 10. The electrode bodies 10 lie next to each other in a third direction D3. The third direction D3 is a direction orthogonal to both the first direction D1 and the second direction D2.

In the following, one electrode body 10 of the electrode bodies 10 will be described. Each of the electrode bodies 10 may include a configuration to be shown below.

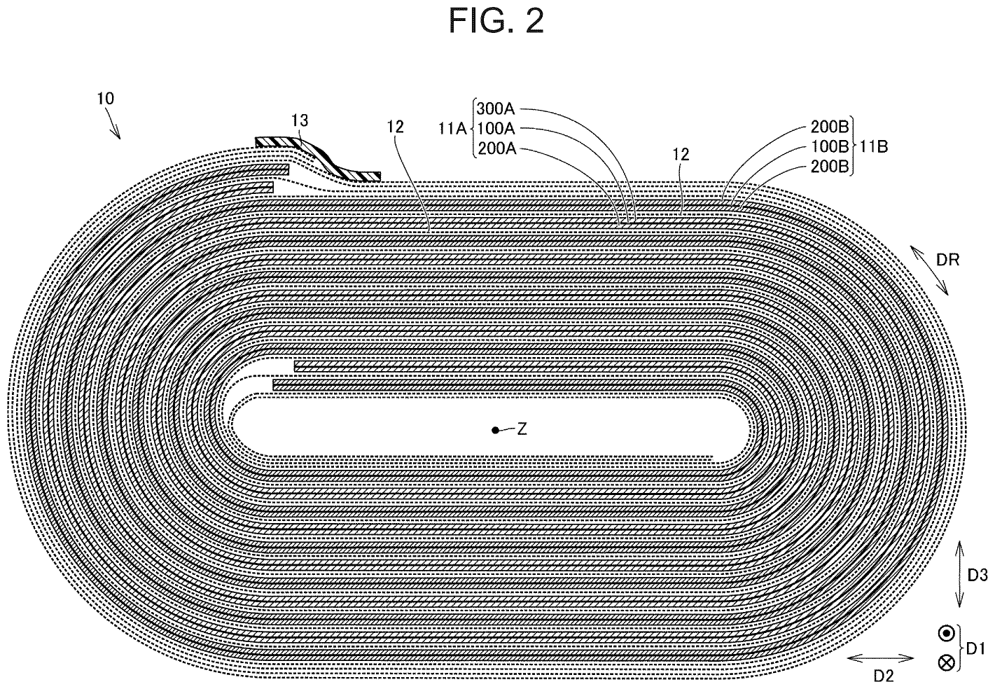

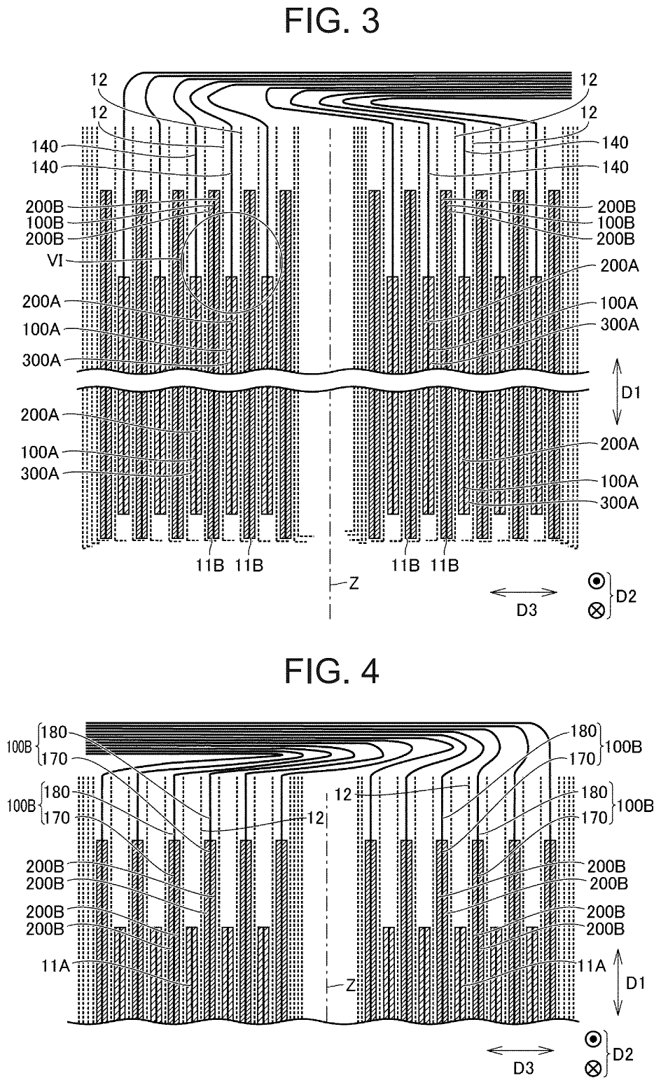

FIG. 2 is a sectional view of the electrode body of FIG. 1 as seen in the arrow direction of line II-II. FIG. 3 is a sectional view of the electrode body of FIG. 1 as seen in the arrow direction of line III-III. FIG. 4 is a schematic sectional view of part of the electrode body of FIG. 1 as seen in the arrow direction of line IV-IV. As shown in FIG. 1 to FIG. 4, the electrode body 10 includes a first electrode 11A, a second electrode 11B, and a separator 12. In the electrode body 10, the first electrode 11A, the second electrode 11B, and the separator 12 are rolled so as to surround a rolling axis Z. Thus, in this embodiment, the electrode body 10 is a so-called rolled electrode body. However, the electrode body 10 may instead be a laminated electrode body in which the first electrode 11A, the second electrode 11B, and the separator 12 are laminated in one direction (e.g., the third direction D3). In FIG. 2 to FIG. 4, the separator 12 is schematically indicated by broken lines.

The first electrode 11A and the second electrode 11B have a sheet-like external shape. The electrode body 10 is formed by a polar plate group in which the first electrode 11A and the second electrode 11B are rolled with one or more separators 12 interposed therebetween.

In this embodiment, the first electrode 11A is a positive electrode and the second electrode 11B is a negative electrode. However, instead, the first electrode 11A may be a negative electrode and the second electrode 11B may be a positive electrode.

The separator 12 is provided between the first electrode 11A and the second electrode 11B. The separator 12 separates the first electrode 11A and the second electrode 11B from each other while allowing ions to travel to and from between the first electrode 11A and the second electrode 11B. These ions are, for example, lithium ions. The separator 12 has electrical insulation properties.

Of the first electrode 11A, the second electrode 11B, and the separator 12, the separator 12 is located farthest on an inner circumferential side around the rolling axis Z. Of the first electrode 11A, the second electrode 11B, and the separator 12, the separator 12 is located farthest on an outer circumferential side around the rolling axis Z. An end edge of the separator 12 on the outer circumferential side in a rolling direction DR is fixed by a tape member 13 disposed on an outer circumferential surface of the separator 12.

The separator 12 may contain, for example, polyolefin-based resin. The separator 12 may be, for example, essentially made of polyolefin-based resin. The polyolefin-based resin may contain, for example, at least one type selected from a group consisting of polyethylene (PE) and polypropylene (PP).

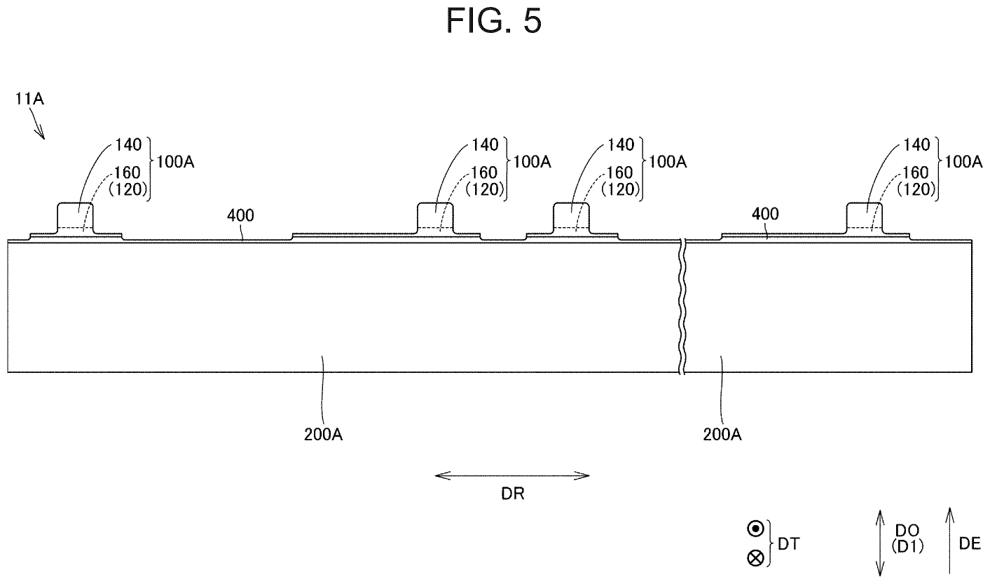

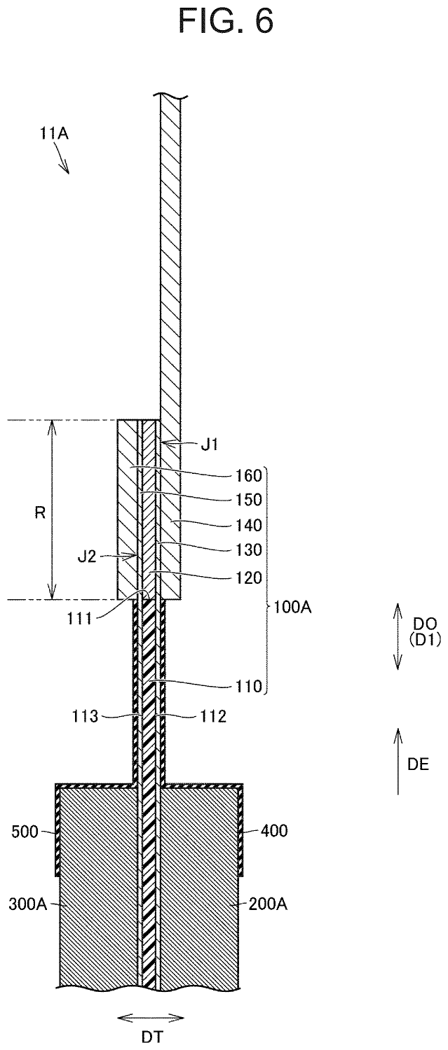

FIG. 5 is a developed view of the first electrode. That is, FIG. 5 shows a state of the first electrode 11A before being rolled. FIG. 6 is a partial sectional view showing a close-up of a region VI of the first electrode in FIG. 3. As shown in FIG. 3 to FIG. 6, the first electrode 11A includes a current collector 100A, a one-side active material layer 200A, an other-side active material layer 300A, a first protective part 400, and a second protective part 500.

The first current collector 100A includes an insulative support layer 110, a plurality of conductive support layers 120, a first conductive layer 130, a plurality of tab parts 140, a second conductive layer 150, and a plurality of joining auxiliary parts 160.

The insulative support layer 110 is made of a resin composition having electrical insulation properties. Thus, the first current collector 100A is a composite current collector composed of a conductive member and an electrically insulative member. As such, compared with when the first current collector 100A is entirely made of metal, the first current collector 100A is lighter and the safety of the entire battery 1 is higher.

The insulative support layer 110 is made of, for example, a resin composition containing polyamide-based resin, polyester-based resin, or polyolefin-based resin. To enhance the rigidity, it is preferable that the insulative support layer 110 be made of a resin composition containing polyester-based resin. It is further preferable that the insulative support layer 110 be essentially made of polyester-based resin. This polyester-based resin may be, for example, polyethylene terephthalate. Thus, the rigidity of the first current collector 100A can be enhanced while the electrical insulation properties of the insulative support layer 110 are maintained. Consequently, the insulative support layer 110 can be made relatively thin.

An orthogonal direction DO orthogonal to a thickness direction DT of the insulative support layer 110 is substantially parallel to the first direction D1. That is, the insulative support layer 110 extends substantially parallel to the first direction D1.

The insulative support layer 110 includes an end face 111, a first face 112, and a second face 113. The end face 111 faces one side in the orthogonal direction DO (first direction D1). The first face 112 is a face facing one side in the thickness direction DT of the insulative support layer 110. The second face 113 is a face facing the other side in the thickness direction DT of the insulative support layer 110.

To reduce the thickness of the entire electrode body 10, the thickness of the insulative support layer 110 is, for example, preferably 20 μm or smaller, more preferably 15 μm or smaller, and further preferably 10 μm or smaller. The thickness of the insulative support layer 110 is not particularly limited as long as desired rigidity is secured. The thickness of the insulative support layer 110 should be, for example, 2 μm or larger.

As shown in FIG. 5, the conductive support layers 120 lie next to one another in the rolling direction DR of the electrode body 10. The conductive support layers 120 are spaced apart from one another. In the following, a configuration of each of the conductive support layers 120 will be described.

As shown in FIG. 6, the conductive support layer 120 lies adjacent to the insulative support layer 110. More specifically, the conductive support layer 120 lies adjacent to the insulative support layer 110 in the orthogonal direction DO (first direction D1). A thickness direction of the conductive support layer 120 is the same direction as the thickness direction DT of the insulative support layer 110. The conductive support layer 120 is in contact with the end face 111.

The conductive support layer 120 has electrical conductivity. The constituent material of the conductive support layer 120 is not particularly limited. It may be metal, such as aluminum or copper, or may be conductive resin. The conductive resin may have conductivity by containing a filler with high conductance, such as carbon or metal.

While the thickness of the conductive support layer 120 is not particularly limited, it is preferably essentially equal to that of the insulative support layer 110. Thus, the first conductive layer 130 and the second conductive layer 150, to be described later, can spread uniformly and substantially parallel to each other in the orthogonal direction DO (first direction D1). The thickness of the conductive support layer 120 is, for example, preferably 20 μm or smaller, more preferably 15 μm or smaller, and further preferably 10 μm or smaller. The thickness of the conductive support layer 120 should be, for example, 2 μm or larger.

The first conductive layer 130 is laminated on both of the insulative support layer 110 and the conductive support layer 120. The first conductive layer 130 is provided on the first face 112 of the insulative support layer 110. The first conductive layer 130 is extended from the insulative support layer 110 at a plurality of sites. More specifically, the first conductive layer 130 is extended so as to stick out from the first face 112. An extension direction DE that is a direction in which the first conductive layer 130 is extended from the insulative support layer 110 is a direction that the end face 111 faces. The extension direction DE may lie along the first direction D1 or lie along the orthogonal direction DO. The conductive support layers 120 are respectively laminated on these extended portions of the first conductive layer 130.

In this embodiment, the first conductive layer 130 is located on the side of the rolling axis Z as seen from the insulative support layer 110. However, the first conductive layer 130 may instead be located on the opposite side from the side of the rolling axis Z as seen from the insulative support layer 110.

As shown in FIG. 5, the tab parts 140 lie next to one another in the rolling direction DR of the electrode body 10. The tab parts 140 are spaced apart from one another. The tab parts 140 lie next to one another in the thickness direction DT so as to correspond one-for-one to the conductive support layers 120.

As shown in FIG. 3, the tab parts 140 are joined to one another by ultrasonic joining or the like. As shown in FIG. 1, the tab parts 140 are further joined to the first coupling member 40A by ultrasonic joining or the like. Thus, the first external terminal 30A is electrically connected to the tab parts 140. In the following, a configuration of each of the tab parts 140 will be described.

As shown in FIG. 6, the tab part 140 lies next to the conductive support layer 120 through the first conductive layer 130. The tab part 140 is joined to the first conductive layer 130 by ultrasonic joining. In FIG. 6, a first joint portion J1 that is a joint portion between the first conductive layer 130 and the tab part 140 is shown. The tab part 140 is extended from a point on the first conductive layer 130 so as to stick out in the extension direction DE. An end edge of the tab part 140 on the opposite side from the side of the extension direction DE lies next to the end face 111 in the thickness direction DT.

The second conductive layer 150 is located opposite from the first conductive layer 130 as seen from the conductive support layer 120. The second conductive layer 150 is provided on the second face 113 of the insulative support layer 110. The second conductive layer 150 is laminated on both of the insulative support layer 110 and the conductive support layer 120. The second conductive layer 150 is extended from the insulative support layer 110 at a plurality of sites. More specifically, the second conductive layer 150 is extended so as to stick out from the second face 113. A direction in which the second conductive layer 150 is extended from the insulative support layer 110 is the same as the extension direction DE that is the direction in which the first conductive layer 130 is extended from the insulative support layer 110. An extension length by which the second conductive layer 150 is extended from the insulative support layer 110 is essentially equal to an extension length by which the first conductive layer 130 is extended from the insulative support layer 110. The conductive support layers 120 are respectively laminated on these extended portions of the second conductive layer 150.

As shown in FIG. 5, the joining auxiliary parts 160 lie next to one another in the rolling direction DR of the electrode body 10. The joining auxiliary parts 160 are spaced apart from one another. The joining auxiliary parts 160 lie next to one another in the thickness direction DT so as to correspond one-for-one to the conductive support layers 120. As seen from the thickness direction DT, each of the joining auxiliary parts 160 has the same external shape as the external shape of the corresponding conductive support layer 120 that lines next to it in the thickness direction DT. In the following, a configuration of each of the joining auxiliary parts 160 will be described.

As shown in FIG. 6, the joining auxiliary part 160 lies next to the tab part 140 through the second conductive layer 150, the conductive support layer 120, and the first conductive layer 130. The joining auxiliary part 160 is joined to the second conductive layer 150 by ultrasonic joining. In FIG. 6, a second joint portion J2 that is a joint portion between the second conductive layer 150 and the joining auxiliary part 160 is shown. In the thickness direction DT, an end edge of the joining auxiliary part 160 that faces the extension direction DE lies next to end edges of the conductive support layer 120, the first conductive layer 130, and the second conductive layer 150 that face the extension direction DE. An end edge of the joining auxiliary part 160 that faces opposite from the extension direction DE lies next to the end face 111 in the thickness direction DT.

The thickness of the first conductive layer 130 is smaller than the thickness of the conductive support layer 120, and is smaller than the thickness of the insulative support layer 110. The thickness of the second conductive layer 150 is smaller than the thickness of the conductive support layer 120, and is smaller than the thickness of the insulative support layer 110. To reduce the thickness of the entire electrode body 10, the thickness of the first conductive layer 130 and the thickness of the second conductive layer 150 are, for example, 5 μm or smaller, more preferably 2 μm or smaller, and further preferably 1 μm or smaller. To keep the electrical resistance of the first conductive layer 130 and the second conductive layer 150 from becoming too high, the thickness of the first conductive layer 130 and the thickness of the second conductive layer 150 should be, for example, 0.1 μm or larger. When the thickness of the first conductive layer 130 and the thickness of the second conductive layer 150 are 5 μm or smaller, it is difficult to directly weld the first conductive layer 130 and the second conductive layer 150 to each other, or to directly join these layers to each other by ultrasonic welding.

The thickness of the tab part 140 and the thickness of the joining auxiliary part 160 are not particularly limited as long as the thicknesses allow ultrasonic joining. The thickness of the tab part 140 and the thickness of the joining auxiliary part 160 are larger than the thickness of the first conductive layer 130, and are larger than the thickness of the second conductive layer 150. The thickness of the tab part 140 and the thickness of the joining auxiliary part 160 are, for example, preferably 20 μm or smaller, more preferably 15 μm or smaller, and further preferably 10 μm or smaller. The thickness of the tab part 140 and the thickness of the joining auxiliary part 160 are not particularly limited as long as desired rigidity is secured. The thickness of the tab part 140 and the thickness of the joining auxiliary part 160 should be, for example, 2 μm or larger.

The formation method of the first conductive layer 130 and the second conductive layer 150 is not particularly limited. In this embodiment, the first conductive layer 130 and the second conductive layer 150 are typically formed by metal films. Thus, the first conductive layer 130 and the second conductive layer 150 are easy to laminate on both of the insulative support layer 110 and the conductive support layer 120. The metal films may be typically manufactured by extrusion. The first conductive layer 130 and the second conductive layer 150 may be bonded to the insulative support layer 110 and the conductive support layer 120 by an adhesive, or may be pressure-bonded to the insulative support layer 110 and the conductive support layer 120 by mechanical roll pressing. The first conductive layer 130 and the second conductive layer 150 are typically made of metal containing aluminum. Thus, the first current collector 100A including the first conductive layer 130 and the second conductive layer 150 can be suitably used as a positive electrode current collector. Alternatively, the first current collector 100A may be a negative electrode current collector, and the first conductive layer 130 and the second conductive layer 150 may be made of metal containing copper.

While the constituent materials of the tab part 140 and the joining auxiliary part 160 are not particularly limited, in this embodiment, the joining auxiliary part 160 is made of the same material that the tab part 140 is made of. The tab part 140 and the joining auxiliary part 160 are formed by, for example, metal films, and are typically made of metal containing aluminum or copper.

The one-side active material layer 200A is laminated on the first conductive layer 130. The other-side active material layer 300A is laminated on the second conductive layer 150. The one-side active material layer 200A and the other-side active material layer 300A are both positive electrode active material layers but may instead be negative electrode active material layers. The one-side active material layer 200A is spaced apart from the tab part 140. The other-side active material layer 300A is spaced apart from the joining auxiliary part 160.

The separator 12 is laminated on the one-side active material layer 200A in a radial direction around the rolling axis Z (see FIG. 3 etc.). The separator 12 is also laminated on the other-side active material layer 300A in the radial direction.

The first protective part 400 is made of ceramic having electrical insulation properties. The first protective part 400 covers part of the one-side active material layer 200A on the side of the extension direction DE. The first protective part 400 covers an entire surface of the first conductive layer 130 between the one-side active material layer 200A and the tab part 140. The first protective part 400 is not disposed between the first conductive layer 130 and the tab part 140.

The second protective part 500 is made of ceramic having electrical insulation properties. The second protective part 500 covers part of the other-side active material layer 300A on the side of the extension direction DE. The second protective part 500 covers an entire surface of the second conductive layer 150 between the other-side active material layer 300A and the joining auxiliary part 160. The second protective part 500 is not disposed between the second conductive layer 150 and the joining auxiliary part 160.

As shown in FIG. 2 to FIG. 4, the second electrode 11B is laminated on the one-side active material layer 200A through the separator 12 in the radial direction. The second electrode 11B is also laminated on the other-side active material layer 300A through the separator 12. While in this embodiment the electrode body 10 includes more than one separator 12, it may instead include one separator 12.

The second electrode 11B includes a second current collector 100B and a second active material layer 200B. The second current collector 100B includes a conductive support part 170 and a plurality of second tab parts 180 (see FIG. 4). The conductive support part 170 extends along the orthogonal direction DO (first direction D1). The second tab parts 180 extend from an upper end of the conductive support part 170. The second tab parts 180 are joined to one another and to the second coupling member 40B by ultrasonic welding (see FIG. 1).

The second tab parts 180 and the conductive support part 170 are formed by integral members, and are formed by, for example, metal films. In this embodiment, the second tab parts 180 and the conductive support part 170 are made of, for example, metal containing copper. Thus, the second current collector 100B can be suitably used as a negative electrode current collector. When the first current collector 100A is a negative electrode current collector and the second current collector 100B is a positive electrode current collector, the second tab parts 180 and the conductive support part 170 may be made of metal containing aluminum.

The second active material layer 200B is laminated on both surfaces of the conductive support part 170 of the second current collector 100B. In this embodiment, the second electrode 11B is a negative electrode. Therefore, the second active material layer 200B is a negative electrode active material layer. The second active material layer 200B may instead be a positive electrode active material layer.

As has been described above, in the battery 1 according to one embodiment of the present disclosure, the current collector 100A includes the insulative support layer 110, the conductive support layer 120, the first conductive layer 130, and the tab parts 140. The insulative support layer 110 is made of a resin composition having electrical insulation properties. The conductive support layer 120 lies adjacent to the insulative support layer 110. The first conductive layer 130 is laminated on both of the insulative support layer 110 and the conductive support layer 120. The tab part 140 lies next to the conductive support layer 120 through the first conductive layer 130 and joined to the first conductive layer 130 by ultrasonic joining.

As described above, when the tab part 140 and the first conductive layer 130 are joined to each other by ultrasonic welding, the conductive support layer 120 may become mixed into the first joint portion J1 that is the joint portion between the first conductive layer 130 and the tab part 140. As a result, in the first joint portion J1, the tab part 140 and the first conductive layer 130 may fail to be uniformly joined to each other. However, since the conductive support layer has conductivity, even when the tab part 140 and the first conductive layer 130 fail to be uniformly joined to each other, conductivity in the first joint portion J1 is less likely to be impaired. Thus, the above-described configuration can reduce heat generation in the first joint portion J1 that is the joint portion between the first conductive layer 130 and the tab part 140. Melting of the conductive support layer 120 can be inhibited by forming the conductive support layer 120 using a material having a higher melting point than the insulative support layer 110. Thus, in the first joint portion J1, the first conductive layer 130 and the tab part 140 can be relatively uniformly joined to each other. Therefore, the above-described configuration can improve the joint strength of the first joint portion J1.

The current collector 100A according to one embodiment of the present disclosure further includes the second conductive layer 150 and the joining auxiliary part 160. The second conductive layer 150 is laminated on both of the insulative support layer 110 and the conductive support layer 120 and located opposite from the first conductive layer 130 as seen from the conductive support layer 120. The joining auxiliary part 160 is made of the same material that the tab part 140 is made of. The joining auxiliary part 160 lies next to the tab part 140 through the second conductive layer 150, the conductive support layer 120, and the first conductive layer 130 and is joined to the second conductive layer 150 by ultrasonic joining.

In this configuration, it is possible to realize improvement in joining uniformity in the first joint portion J1 and the second joining portion J2 less expensively by forming, at the same time as the first joint portion J1, the second joint portion J2 that is the joint portion between the joining auxiliary part 160 and the second conductive layer 150 by ultrasonic joining. Consequently, in a conduction path from the second conductive layer 150 to the tab part 140, heat generation in the second joint portion J2 and the first joint portion J1 can be reduced. The first joint portion J1 and the second joint portion J2 can be formed by, for example, holding a region R where the conductive support layer 120, the first conductive layer 130, the tab part 140, the second conductive layer 150, and the joining auxiliary part 160 are laminated on one another between a horn and an anvil for ultrasonic joining (neither is shown).

In the battery 1 according to one embodiment of the present disclosure, the first electrode 11A further includes the first protective part 400 and the second protective part 500. The first protective part 400 is made of ceramic having electrical insulation properties. The first protective part 400 covers part of the one-side active material layer 200A and covers the entire surface of the first conductive layer 130 between the one-side active material layer 200A and the tab part 140, and is not disposed between the first conductive layer 130 and the tab part 140. The second protective part 500 is made of ceramic having electrical insulation properties. The second protective part 500 covers part of the other-side active material layer 300A and covers the entire surface of the second conductive layer 150 between the other-side active material layer 300A and the joining auxiliary part 160, and is not disposed between the second conductive layer 150 and the joining auxiliary part 160.

In this configuration, the first protective part 400 can inhibit a metallic foreign substance resulting from joining of the tab part 140 and another member to each other from coming into contact with the first conductive layer 130 or the one-side active material layer 200A. Since the first protective part 400 is not disposed between the first conductive layer 130 and the tab part 140, the first conductive layer 130 and the tab part 140 can be brought into close contact with each other when forming the first joint portion J1. Consequently, a decrease in the joint strength of the first joint portion J1 can be avoided. Further, the second protective part 500 can inhibit a metallic foreign substance resulting from joining of the tab part 140 and another member to each other from coming into contact with the second conductive layer 150 or the other-side active material layer 300A. Since the second protective part 500 is not disposed between the second conductive layer 150 and the joining auxiliary part 160, the first conductive layer 130 and the tab part 140 can be brought into close contact with each other when forming the first joint portion J1 together with the second joint portion J2. Consequently, a decrease in the joint strength of the second joint portion J2 can be avoided.

In the description of the embodiment given above, configurations that can be combined may be combined with one another.

The embodiment disclosed this time should be construed as being in every respect illustrative and not restrictive. The scope of the present disclosure is indicated not by the above description but by the claims, and is intended to include all changes within the meaning and scope of equivalents of the claims.

What is claimed is:

1. A current collector comprising:
an insulative support layer;
a conductive support layer;
a first conductive layer; and
a tab part, wherein:
the insulative support layer is made of a resin composition having electrical insulation properties;
the conductive support layer lies adjacent to the insulative support layer;
the first conductive layer is laminated on both of the insulative support layer and the conductive support layer; and
the tab part lies next to the conductive support layer through the first conductive layer and is joined to the first conductive layer by ultrasonic joining.

2. The current collector according to claim 1, further comprising:
a second conductive layer; and
a joining auxiliary part, wherein:
the second conductive layer is laminated on both of the insulative support layer and the conductive support layer and located opposite from the first conductive layer as seen from the conductive support layer;
the joining auxiliary part is made of the same material that the tab part is made of; and
the joining auxiliary part lies next to the tab part through the second conductive layer, the conductive support layer, and the first conductive layer and is joined to the second conductive layer by ultrasonic joining.

3. A battery comprising:
an electrode body; and
an external terminal, wherein:
the electrode body includes a first electrode, a second electrode, and a separator;
the first electrode includes a current collector and a one-side active material layer;
the current collector includes an insulative support layer, a conductive support layer, a first conductive layer, and a tab part;
the insulative support layer is made of a resin composition having electrical insulation properties;
the conductive support layer lies adjacent to the insulative support layer;
the first conductive layer is laminated on both of the insulative support layer and the conductive support layer;
the tab part lies next to the conductive support layer through the first conductive layer and is joined to the first conductive layer by ultrasonic joining;
the one-side active material layer is laminated on the first conductive layer;
the separator is laminated on the one-side active material layer;
the second electrode is laminated on the one-side active material layer through the separator; and
the external terminal is electrically connected to the tab part.

4. The battery according to claim 3, wherein:
the first electrode further includes an other-side active material layer;
the current collector further includes a second conductive layer and a joining auxiliary part;
the second conductive layer is laminated on both of the insulative support layer and the conductive support layer and located opposite from the first conductive layer as seen from the conductive support layer;
the joining auxiliary part is made of the same material that the tab part is made of;
the joining auxiliary part lies next to the tab part through the second conductive layer, the conductive support layer, and the first conductive layer and is joined to the second conductive layer by ultrasonic joining;
the other-side active material layer is laminated on the second conductive layer;
the separator is further laminated on the other-side active material layer; and
the second electrode is further laminated on the other-side active material layer through the separator.

5. The battery according to claim 4, wherein:
the first electrode further includes a first protective part and a second protective part;
the first protective part is made of ceramic having electrical insulation properties;
the first protective part covers part of the one-side active material layer and covers an entire surface of the first conductive layer between the one-side active material layer and the tab part, and is not disposed between the first conductive layer and the tab part;
the second protective part is made of ceramic having electrical insulation properties; and
the second protective part covers part of the other-side active material layer and covers an entire surface of the second conductive layer between the other-side active material layer and the joining auxiliary part, and is not disposed between the second conductive layer and the joining auxiliary part.
